(19) United States
(12) Patent Application Publication
(10) Pub. No.: US 2013/0343743 A1
(43) Pub. Date: Dec. 26, 2013

(54) PANORAMA PHOTOGRAPHY PTZ FOR MOBILE COMMUNICATION DEVICES

(71) Applicant: Cheng-Fong YEN, Changhua County (TW)

(72) Inventor: Cheng-Fong YEN, Changhua County (TW)

(21) Appl. No.: 13/529,643

(22) Filed: Jun. 21, 2012

(51) Int. Cl. G03B 17/00

(52) U.S. Cl. 396/428

(57) ABSTRACT

A panorama photography PTZ for mobile communications devices has a rotary table at a base, and a flipping element provided on one side of the rotary table and having a fixing part, a first driving element to horizontally rotate the rotary table with respect to the base rotation, a second driving element to rotate the flipping element with respect to the rotary, a control unit electrically connecting to the first driving element and the second driving device, thereby controlling the horizontal rotation of the rotary table and the flipping of the flipping element.

### BACKGROUND OF THE INVENTION

1. Field of Invention

The invention relates to a mobile accessory and, in particular, to a panorama photography pan tilt zoom (PTZ) for mobile communication devices.

2. Related Art

For cell phones, photography (including static and dynamic) has become an indispensable function. In particular, mobile communication devices are very popular. By downloading some application, the user will be able to enjoy all kinds of photography functions, among which panorama photography is a considerably popular feature.

When using the panorama photography feature, most of the mobile communication device users simply hold the mobile phone and then move down the scene they want to shoot. Very often, it occurs that shooting is interrupted halfway due to too fast or too slow moving speed. Even if the panorama is successfully taken, the movie may not maintain perfect level due to user's trembling. Therefore, the panorama usually has some distortion.

### SUMMARY OF THE INVENTION

An objective of the invention is to solve the above problems and to provide a panorama photography PTZ for a mobile communication device, so that the mobile communication device can move at a constant speed while shooting a panoramic scene. The camera lens can be maintained at same height while moving, thereby solving the problem of interruptions and image distortions.

To achieve the above objective, the invention include:

a base;

a rotary table disposed horizontally and in a pivotal way on the base;

a flipping element provided on one side of the rotary table to flip in the vertical direction and having a fixing part for fixing a mobile communication device;

a first driving element for driving the rotary table to rotate horizontally with respect to the base;

a second driving element for driving the flipping element to flip with respect to the rotary table; and

a control unit electrically connecting to the first driving element and the second driving element, thereby controlling the horizontal rotation of the rotary table and the flip the flipping element, respectively.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional view of the invention;

FIG. 2 is an exploded view of the invention;

FIG. 3 is a schematic view of the lens of a mobile communication device facing a scene to be shot;

FIG. 4 is a cross-sectional view of the invention and how the flipping element flips vertically;

FIG. 5 is a schematic view of the horizontal rotation of the rotary table; and

FIG. 6 is a control block diagram for the control unit to receive a signal from the mobile communication device and to control the first driving element and the second driving element.

### DETAILED DESCRIPTION OF THE INVENTION

The present invention will be apparent from the following detailed description, which proceeds with reference to the accompanying drawings, wherein the same references relate to the same elements.

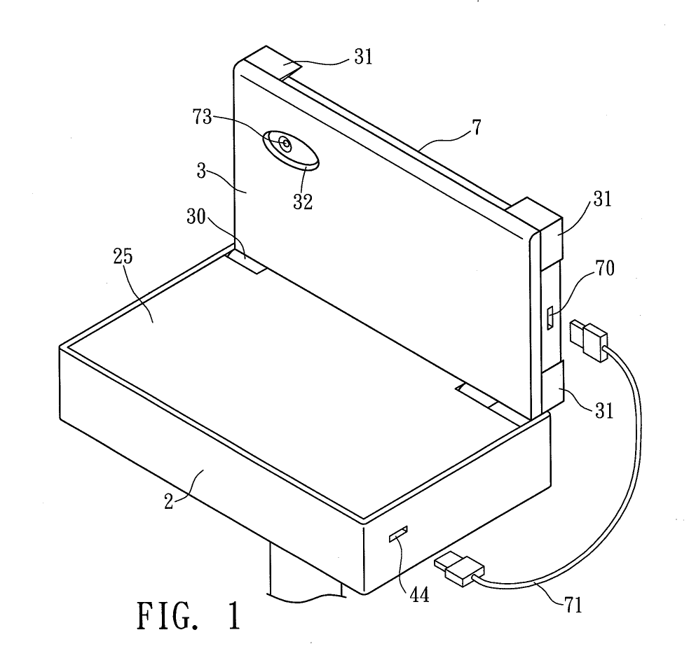

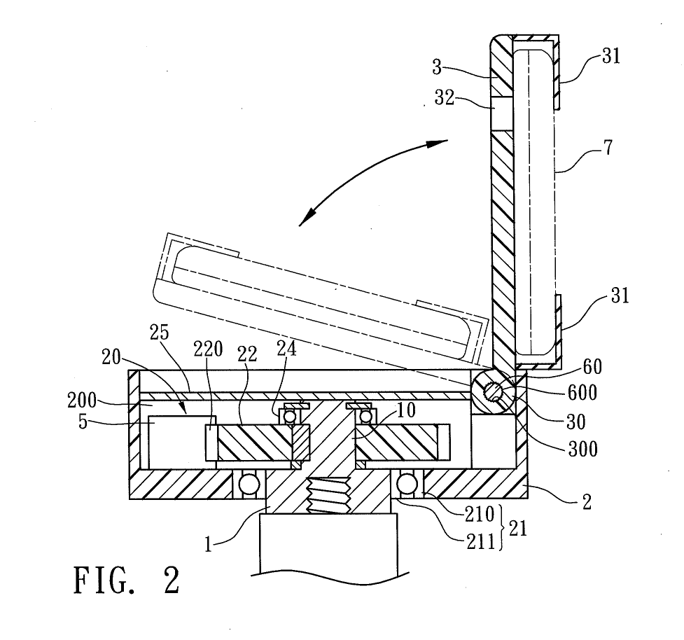

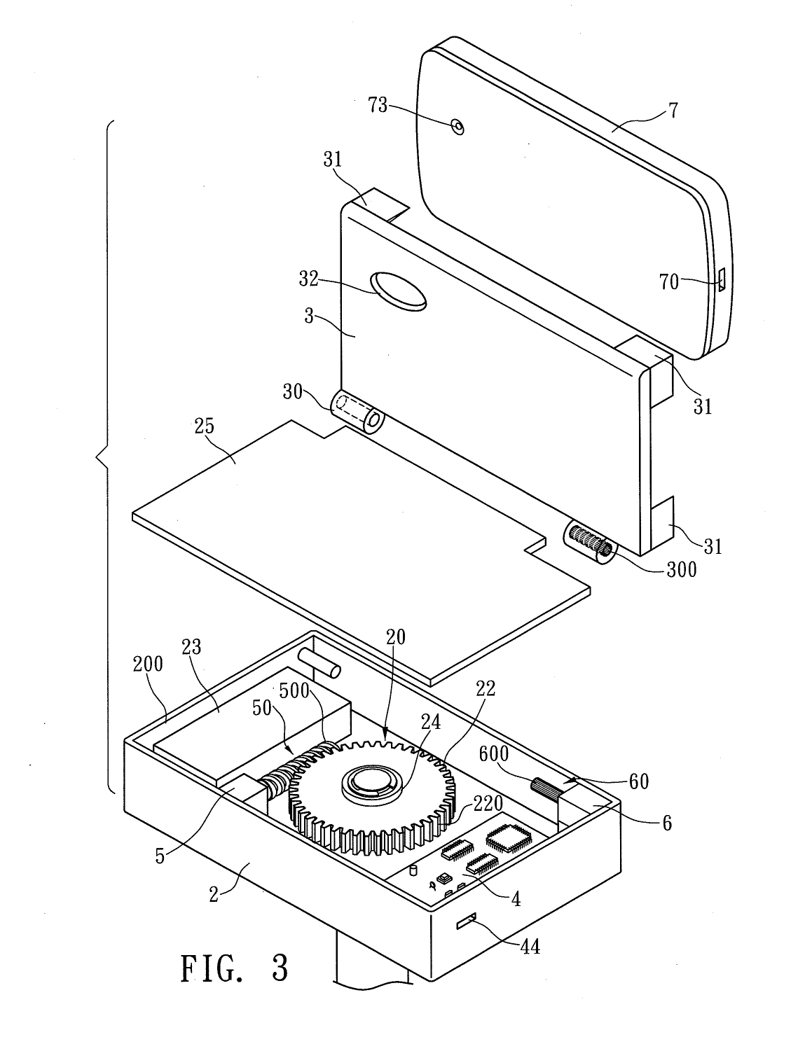

Please refer to a FIGS. 1 to 6 for an embodiment of the invention. This embodiment provides a panorama photography PTZ for mobile communications devices. As shown in FIG. 3, the invention includes a base 1, a rotary table 2, a flipping element 3, a control unit 4, a first driving element 5, and a second driving element 6.

The rotary table 2 has a chamber 20 with an opening 200 facing upward. The opening 200 has a cover 25. The rotary table has a bearing 21 at the bottom of the chamber 20. The bearing 21 contains an outer ring 210 and an inner ring 211 that can rotate with respect to each other. The rotary table is combined with the outer ring 210. The base has a shaft 10 inserted through the inner ring 211 and into the chamber 20 of the rotary table 2. The shaft 10 within the chamber 20 is connected with a turntable 22. The protruding end is connected with another bearing 24. The surrounding of the turntable 22 is a first tooth part 220. The first driving element 5 is a horizontal rotary micro motor. The output shaft 50 of the first driving element 5 has a second tooth part 500 to engage with the first teeth part 220. The first driving element 5 drives its output shaft 50 to rotate. The second tooth part 500 engages with the first tooth part 220 and drives the rotary table 2 to rotate with respect to the base 1. The rotary table 2 in this embodiment has a battery box 23 in the chamber 20 for accommodating lithium batteries (not shown).

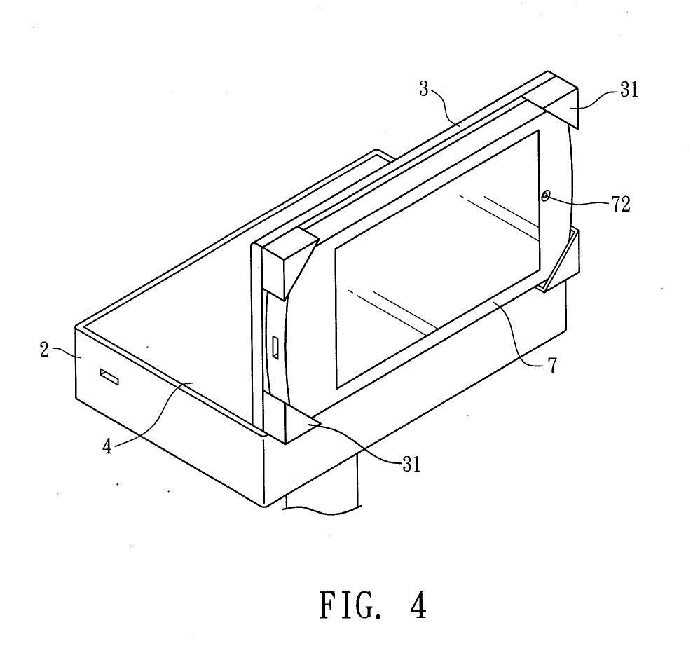

As shown in FIG. 3, the flipping element 3 has a pivotal connection part 30 on the end of the rotary table and a fixing part 31, as shown in FIG. 4, for fixing a mobile communication device 7. The pivotal connection part 30 has an inner tooth section 300. The second driving element 6 is a vertically rotating micro motor. The output shaft 60 of the second driving element 6 has an outer tooth section 600 inserted into the pivotal connection part 30 and engaging with the inner tooth section 300. The second driving element 6 drives its output shaft 60 to rotate. The engagement between the outer tooth section 600 and the inner tooth section 300 drives the flipping element 3 to rotate with respect to the rotary table 2.

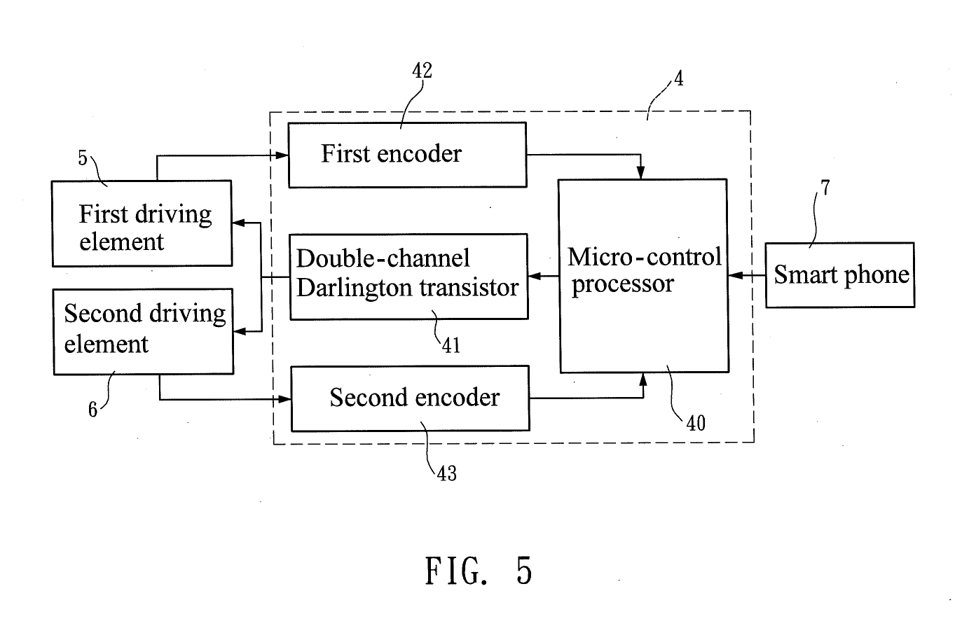

As shown in FIG. 5, the control unit 4 is disposed in the chamber 20 of the rotary table 2 and communicates signals with the mobile communication device 7. The control unit 4 contains a micro-control processor 40, a current amplifier 41, a first encoder 42, and a second encoder 43. After receiving a mobile phone signal, the micro-control processor 40 processes the signal and receives the signals returned from the first encode 42 and the second encoder 43, testing whether the procedure is correctly performed. After receiving a signal from the first driving element 5, the first encoder 42 checks whether to go to a specific address of a program. After receiving a signal from the second driving element 6, the second encoder 43 checks whether the to go to a specific address of a program.

The control unit 4 can be controlled through the link with the mobile communication device. The mobile communication device 7 sends a signal to the micro-control processor 40. After being processed by the micro-control processor 40, the signal is sent to the current amplifier 41 and distributed by the current amplifier 41 to the first driving element 5 and the second driving device 6. The signal to the first driving element 5 is encoded by the first encoder 42 and then sent back to the micro-control processor 40. The signal to the second driving element 6 is encoded by the second encoder 43 and then sent back to the micro-control processor 40. The signals returned from the first encoder 42 and the second encoder 43 are processed by the micro-control processor 40 and then received by the mobile communication device 7.

Moreover, the signal exchanges between the control unit 4 and the mobile communication device 7 include cable and/ore wireless transmissions. This embodiment uses the cable transmission. As shown in FIG. 1, the control unit 4 has a slot 44 on the rotary table 2. The mobile communication device 7 also has a slot 70. A transmission line 71 connects between the slots 44, 70, thereby electrically connecting the control unit 4 and the mobile communication device 7. Besides, the electrical connection between the control unit 4 and the mobile communication device 7 can also be wireless transmissions, including Wi-Fi (Wireless Fidelity), Bluetooth, the third generation (3G) mobile communications, the fourth generation (4G) mobile communications, and infrared transmissions.

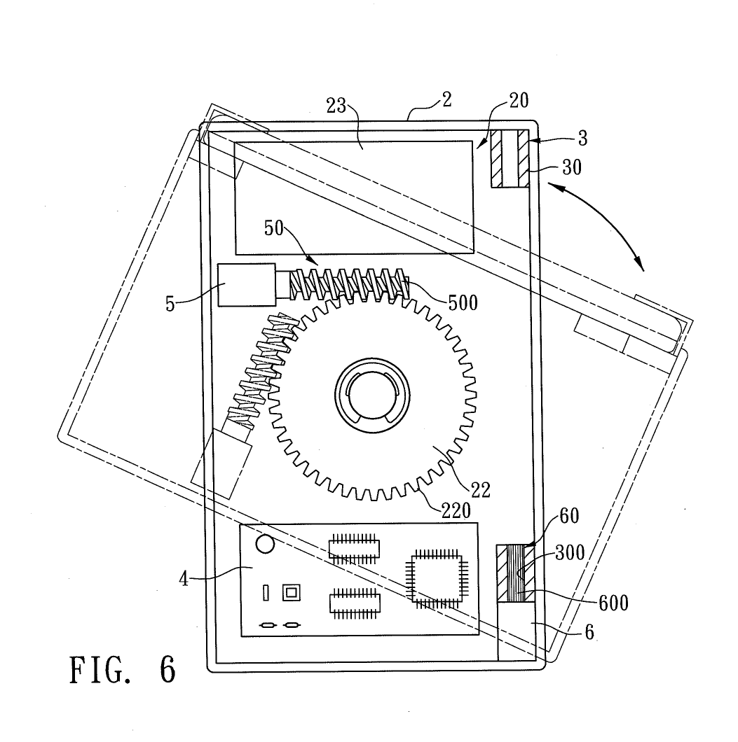

When using the photography PTZ of this embodiment to shoot a panoramic scene, one has to first fix the mobile communication device on the flipping element 3 via the fixing part 31. The control unit 4 controls the second driving element 6 to drive its output shaft 60 to rotate the flipping element 3, so that the flipping element 3 flips from the horizontal posture to a default posture (90 degrees in this embodiment). The front lens 72 or the rear lens 73 of the mobile communication device 7 (the flipping element should be correspondingly formed with a lens hole 32 corresponding to the rear lens 73) faces toward the scene to shoot. In this case, the control unit 4 controls the first driving element 5 to drive its output shaft 50. As shown in FIG. 6, the rotary table 2 is horizontal and driven to rotate at a constant speed at the same height. It starts from the beginning of the scene, rotates horizontally, and stops at the end of the scene, completing a panoramic scene shooting.

It is not difficult to discover that the advantages of the invention according to the above description. The mobile communications device 7 is connected by the fixing part 31 to the flipping element 3. The flipping element 3 flips and positions at a particular shooting angle. The horizontal rotation of the rotary table 2 at a constant speed prevents interruptions of shooting because of the rotation being too fast or too slow. The lens 72 is maintained at the same height and does not produce distortions due to hand shaking. The invention can thus provide the stability of the mobile communication device in panorama photography.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A panorama photography pan tilt zoom (PTZ) for mobile communication devices, comprising:
a base;
a rotary table disposed on the base in a horizontally rotatable way;
a flipping element disposed on one side of the rotary table to flip vertically and having one fixing part for fixing a mobile communication device;
a first driving element to drive the rotary table to rotate horizontally with respect to the base;
a second driving element to drive the flipping element to flip with respect to the rotary table; and
a control unit electrically connecting to the first driving element and the second driving element to control the horizontal rotation of the rotary table and the flipping of the flipping element.

2. The panorama photography PTZ of claim 1, wherein the rotary table is formed with a chamber having an upward opening with a cover; the rotary table has a bearing at the bottom of the chamber, the bearing containing an outer ring and an inner ring that are rotatable with respect to each other; the rotary table is combined with the outer ring; the base has a shaft inserted through the inner ring into the chamber of the rotary table; the shaft inside the chamber is connected with a turntable, and the protruding end thereof is connected with another bearing; the surrounding of the turntable has a first tooth part; the output shaft of the first driving element has a second tooth part engaging with the first tooth part; and the first driving element drives the output shaft thereof to rotate, so that the engagement between the second toot part and the first tooth part rotate the rotary table with respect to the base.

3. The panorama photography PTZ of claim 1, wherein the flipping element has a pivotal connection part on the end of the rotary table; the pivotal connection part has an inner tooth section; the output shaft of the second driving element has an outer tooth section inserted into the pivotal connection part to engage with the inner tooth section; the second driving element drives the output shaft thereof to rotate, so that the engagement between the second toot part and the first tooth part rotate the rotary table with respect to the base.

4. The panorama photography PTZ of claim 1, wherein the control unit is disposed in the chamber of the rotary table and transmit signals with the mobile communication device; the control unit includes a micro-control processor, a current amplifier, a first encoder, and a second encoder; the mobile communication device sends a signal to the micro-control processor to process and then send to the current amplifier; the signal is then distributed by the current amplifier to the first driving element and the second driving element; the signal to the first driving element is encoded by the first encoder and returned to the micro-control processor; the signal to the second driving element is encoded by the second encoder and returned to the micro-control processor; and the signals returned from the first encoder and the second encoder are processed by the micro-control processor and received by the mobile communication device.

5. The panorama photography PTZ of claim 4, wherein the signal transmission between the control unit and the mobile communication device includes wired and wireless transmissions.

6. The panorama photography PTZ of claim 5, wherein the wired transmission is a transmission line electrically connected between the control unit and the mobile communication device.

7. The panorama photography PTZ of claim 5, wherein the wireless transmission include Wi-Fi, Bluetooth, the third generation mobile communication, the fourth generation mobile communication, and infrared transmissions.

8. The panorama photography PTZ of claim 4, wherein the chamber of the rotary table has a battery box for accommodating lithium batteries.
